(19) United States
(12) Patent Application Publication
(10) Pub. No.: US 2010/0107260 A1
(43) Pub. Date: Apr. 29, 2010

(54) DEVICE FOR RECEIVING DIGITAL BROADCASTS

(75) Inventors: Martin Orrell, Melbourn Hertfordshire (GB); Tristan Barkley, Melbourn Hertfordshire (GB); David Tegerdine, Melbourn Hertfordshire (GB); Antony Rix, Melbourn Hertfordshire (GB)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: THE TECHNOLOGY PARTNERSHIP PLC, Melbourn Hertfordshire (UK)

(21) Appl. No.: 12/528,471

(22) PCT Filed: Feb. 26, 2008
(86) PCT No.: PCT/EP2008/052320

§ 371 Date: Sep. 21, 2009

(30) Foreign Application Priority Data
Feb. 26, 2007 (GB) 0703695.7

(51) Int. Cl. H04L 9/00; H04L 27/00

(52) U.S. Cl. 726/27; 375/316

(57) ABSTRACT

A device comprising a receiver for receiving a broadcast; a processor for processing said broadcast to extract at least one data channel or service from said broadcast means for connecting said device to user equipment, said connecting means being arranged to establish a connection with said user equipment whereby said extracted data channel or service can be transferred securely to said user equipment.

The present invention relates to a device for receiving digital broadcasts and in particular but not exclusively to a device for receiving digital radio or television broadcasts.

Digital television and radio broadcasts are known. With digital television, moving pictures and sound are broadcast in a form of digital signals. Typically, the digital signals are digital modulation data which has been digitally compressed. However, there is no single standard for digital TV. For example, standard definition television SDTV and high definition HDTV are known. In Europe, the standard is DVB (Digital Video Broadcasting) in contrast, in the US there is the ATSC (Advanced Television Systems Committee) whilst in Japan there is the ISDB (Integrated Services Digital Broadcasting) standard.

In addition to these standards, there are so called “mobile TV” standards which relate to the reception of TV on handheld devices such as mobile phones or the like. Examples of such mobile TV standards include DVB-H (Digital Video Broadcasting-Handheld), digital multimedia broadcasting (DMB), Mediaflo, and multimedia broadcast multicast services (MBMS).

DAB digital audio broadcasting is for the broadcast of audio information only, again as a digital signal.

According, to add digital radio or television capabilities to a mobile phone or similar user equipment requires either a chip set incorporated in the phone or an accessory such as a SD card. However, the SD card proposal suffers from problems. Firstly, different user equipment such as mobile phones have different SD card slots. Secondly, the SD card slots are generally provided inside the mobile phone, under a battery. This causes a problem as the digital radio or TV receivers require an antenna, the effectiveness of which is reduced by the battery.

Incorporating digital broadcast receivers into a mobile phone is complex. As set out above, there are a number of different standards using different frequency bands. Accordingly, in order to incorporate a universal digital broadcast receiver into a phone requires a complex multi-band receiver and antenna to be incorporated in the very small space next to the mobile transmitter.

Furthermore, a number of the digital radio or television services are so-called pay services. To support the services requires secure hardware and data paths. Digital rights management systems allow flexible content delivery and storage but make a number of requirements on the device hardware and operating systems. Conditional access systems have similar issues as the digital rights management but in addition they do not allow easy recording if the content is to continue to be protected.

It is an aim of embodiments of the present invention to address one or more of the problems set out above.

Aspects of the present invention can be seen from the appended claims.

For a better understanding of the present invention and as to how the same may be carried into effect, reference will now be made by way of example only to the accompanying drawings in which:

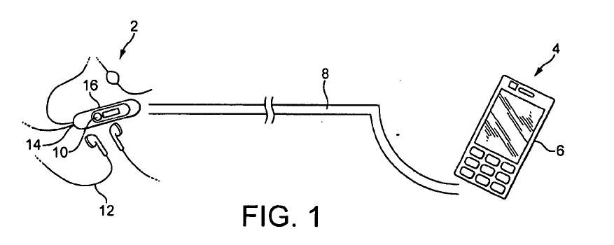

FIG. 1 shows a device embodying the present invention connected to a mobile telephone;

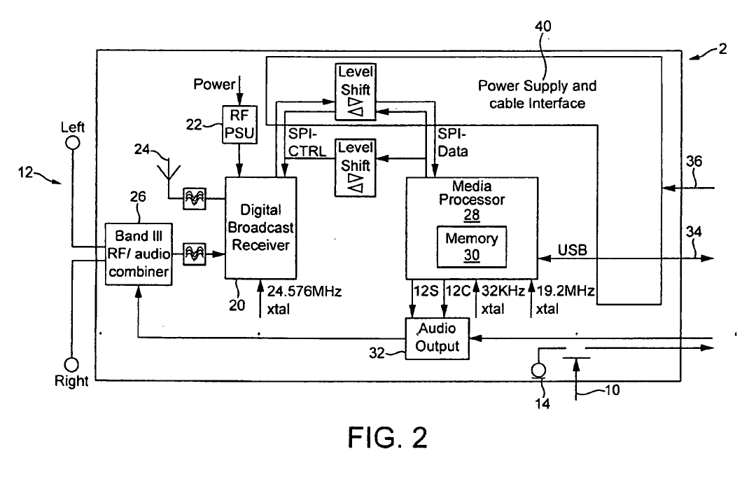

FIG. 2 shows the circuitry incorporated in the device of FIG. 1;

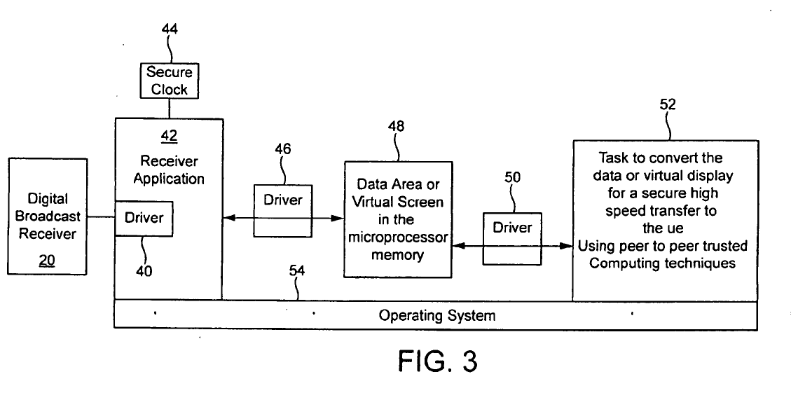

FIG. 3 shows a schematic view of the software incorporated in the device embodying the present invention; and

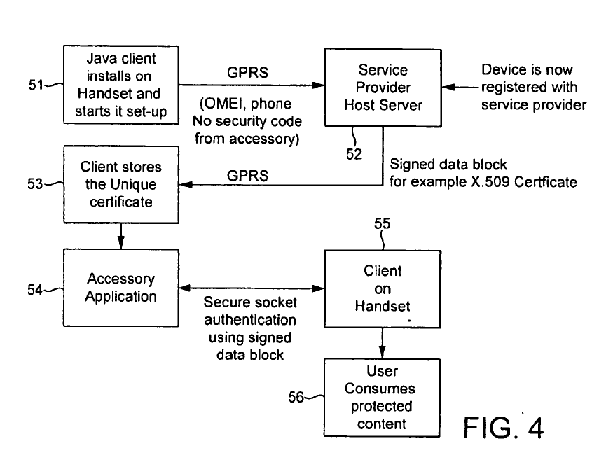

FIG. 4 shows schematically a method embodying the present invention.

Reference is made to FIG. 1 which shows a device 2 embodying the present invention connected to user equipment 4. The user equipment 4 can take any suitable format and may for example be a mobile telephone, a PDA (Personal Digital Assistant), a portable computer such a laptop, a mobile communication device or a mobile computing device. In preferred embodiments of the present invention, where images or moving pictures are received, it is preferred that the user equipment 4 comprises a screen 6. If digital radio or digital audio signals are to be received, the user equipment 4 can be any suitable device but does not require the presence of a screen.

The user equipment 4 is connected to the device 2 embodying the present invention by any suitable connection. In one embodiment of the present invention, the connection 8 comprises a USB connection or any other suitable serial interface. In the alternative, the connection between the user equipment 4 and the device embodying the present invention may be via a wireless connection. The wireless connection can take any suitable form and could for example be a Bluetooth or other short range wireless connection.

The device embodying the present invention comprises a button 10. This button 10 is provided for those devices which are to be connected to a telephone in order to permit the user to answer the phone via the device 2. Connected to the device 2 is a pair of headphones 12. The headphones may incorporate an antenna. In particular, the lead between the device body and the earphone may itself act as an antenna. The headphones may be detachably connected to the device.

The device 2 may comprise a microphone 14. This is particularly useful for those devices 2 which are to be connected to a phone. This allows the user to speak. The user can hear the phone call via the headphones 12. The headphones 12 can also be used to listen to digital radio signals. The device 2 also comprises a volume control 16. This can be used to control the volume provided by the headphones 12 either for a received call or for audio signals from digital radio or digital TV.

The device 2 is preferably small and portable.

The device 2 embodying the invention may be a small portable device which is able to provide broadcast reception of digital signals. The device 2 may not be provided with a display or a keypad. Instead the display and/or keypad of the user equipment are utilized. By not requiring the presence of for example an integral screen in the device means that the power consumption is reduced. This is particularly true when the display is a graphics screen and needs a backlight to be viewed. By not requiring a key pad, the flexibility for antenna design and placement is increased, again affecting the overall packaging. Thus the device 2 embodying the invention may be low cost, light and rugged.

As the device 2 in some embodiments of the invention is not provided with a keypad and/or a screen means that the device 2 can be made to be very small and therefore easy to wear by a user. The device may thus be in the form of an in ear device (such as a mono Bluetooth headset) or a necklace style headphone set. Additionally this allows a better RF performance.

The device 2 embodying the invention may be used, for example with outdoor highly mobile users. Some broadcast networks, such as for example. DAB were planned for either home or car receivers with good aerials. However the arrangement of the device is such that good RF performance is achieved and so is able to receive the signals. The antenna arrangement of preferred embodiments is described in more detail later.

Reference is now made to FIG. 2 which shows diagrammatically the elements incorporated in the device 2 of FIG. 1. The device 2 comprises a digital broadcast receiver that covers the frequency bands of interest. The digital broadcast receiver may be capable of receiving signals in a number of different frequency bands of interest and/or in a number of different formats. In the alternative, the digital broadcast receiver may be designed for a particular standard or format. By way of example, the device may be suitable for receiving any one or more of the standards mentioned previously or any other suitable standard.

The digital broadcast receiver is connected to a power supply unit 22 to provide a RF power supply. The digital broadcast receiver 20 is also arranged to receive inputs from various antenna. In the arrangement for DAB shown in FIG. 2, the digital broadcast receiver 20 is connected to an L-band antenna 24 arranged inside the device 2. The L-band corresponds roughly to 1.39 to 1.55 GHz which is used for the DAB broadcasting in some countries. This is by way of example only and any suitable antenna covering a range of frequencies of interest may be provided.

The lead of the headset 12 may provide an antenna particularly for those frequencies below about 900 MHz where the wavelength does not allow the antenna to be integrated into the body of the device 2. For this purpose a combiner 26 is provided. This combiner 26 allows received radio frequency signals from the antenna part of the headphone to be passed to the digital broadcast receiver 20 and at the same allows audio signals either from the digital broadcast signals or from the user equipment 4 to go to the headphones 12.

Multiple antennas may be fitted inside the device 2 to cover the frequency band of interest.

The digital broadcast receiver is arranged to provide received data (either audio data alone or image and/or audio data) to a microprocessor 28. In one modification to an embodiment of the invention, the digital broadcast receiver may be integrated into the microprocessor 28. The microprocessor 28 is provided with software to allow remote control from the application of the user equipment of the digital broadcast receiver; service discovery and scanning of frequency bands; service tuning and selection; data storage; audio, video and multimedia service streaming to the user equipment 4; and in the case of digitally rights management or conditional access services content decryption and secure transfer of the data to the user equipment 4. The host microprocessor comprises a memory 30. This memory 30 may store received digital broadcasts. In the alternative, the memory may be separate from the microprocessor. The memory 30 is preferably incorporated in the processor 28 as this provides security advantages and makes the device more compact. This memory comprises permanent and/or temporary memory.

The built-in clock may be locally powered and not accessible by the user to ensure that the digital rights management can maintain accurate knowledge of the period of use and the associated rights. The microprocessor can be arranged to check the date and time broadcast in the digital signal against its own local clock to ensure that it is correct and that there has been no tampering that would effect the digital rights management.

The device 2 comprises an audio output function 32. The audio output function is connected to the combiner 26. This is to output audio signals to the headphones 12. The audio output receives an audio output from the media processor 28 and/or an audio output from the user equipment 4.

The device has a microphone 14 and a call-answer button 10. By depressing the call-answer button 10 the microphone is connected to the user equipment 4.

The device 2 has a USB port 34. The USB port is connected to the processor 28. This allows data to pass to and from the user equipment 4. The device 2 also has a power input 36, from the user equipment in one embodiment of the invention. In the alternative, a separate power source may be provided for the device 2 in the device.

A power supply and cable interface 40 is provided between the power input 36 and the USB port on the one hand and the processor 28 and the digital broadcasting receiver 20 on the other hand.

The device of FIG. 2 provides reception of digital broadcast services with protected content to mass market mobile phones and portable devices without hardware modification. The device 2 can therefore be regarded as an accessory. The device embodying the present invention may have a high degree of intelligence. This means that the device 2 can be used with user equipment which do not have the capability to display TV, multimedia services or protected services on their own and do not have the software or hardware security systems for pay services.

Thus, embodiments of the present invention may provide a small and low cost method of enabling handsets currently in the market to be simply upgraded by the user or operator for multimedia services where content protection is provided. Embodiments of the present invention may use a characteristic that a large number of mobile phones support Java for gaming, and thus can draw at high speed on the screen. This means that TV can be upgraded in software without requiring hardware assistance.

Embodiments of the present invention provide an application for free to air TV that can be used with a number of different methods for reception from broadcast to streaming. In the case of streaming, the protected content may be streamed over a 3G network to the accessory via the handset. Embodiments of the present invention are particularly-applicable to broadcast pay TV and multimedia services including file download. Embodiments of the invention may assist streaming over other networks for example WiFi or GSM (Global System for Mobile communication). This could be in the form of rights management, programme information, or programme selection.

At the moment, there are two popular options for delivery of content from broadcast in a secure way. One is digital rights management and the other is conditional access.

Effectively digital rights management is designed to control access to and usage of digital data. Conditional access is a protection of content by requiring certain criteria to be met before granting access to the content.

It should be appreciated that these two popular options may be open standard based or proprietary. One advantage of some embodiments of the invention is that any of these methods of protection, or indeed any alternative of protection can be dealt without the need to provide special hardware or software functionality on the mobile phone.

Device 2 is arranged to provide all the functions of the digital broadcast reception from the antenna to an output via for example the USB port that a simple phone application can render to the screen in a secure way.

Typically, with the available protection, there are a number of restrictions of what can be accessible to a user for security systems. The microprocessor must therefore have its own clock with a method to stop user tampering.

In embodiments of the present invention, these components are used with a suitable operating system and application.

Multiple receivers may be provided to allow simultaneous reception whilst looking for new services or to improve reception through techniques such as antenna diversity.

The application may on first use search or prompt the user to search for new services. Once the user selects a service this will be decoded on the processor 28. This service for example could be:
1. A free-to-air audio service. In this case to save power the processor 28 may decode the audio information locally and send it directly to the headset 12. The user equipment software will act as a simple remote control. If recording of the audio service is allowed or the user selects the user equipment speaker as an output then the audio data will be streamed over the physical interface (USB port) to be played by the application on the user equipment. This may need the microprocessor 28 to decode and convert the data to a suitable format depending on the user equipment capabilities.
2. A pay radio service. In this case to save power the processor will check from the local content protection store in the memory 30 that the user has rights and if allowed decode the audio locally and send it directly to the headset 12. The user equipment software will act as a simple remote control. If recording is allowed or the user selects the user equipment speaker as an output then the audio data will be streamed in a secure manner over the interface, via the USB port, to be played by the application on the user equipment. This may need the microprocessor to decode and convert the data to a suitable format depending on the user equipment capabilities.
3. A file download service. There are a number of open standards for file delivery for example MOT in DAB and Flute in DVB-H. The processor 28 will have an appropriate decoder for the standard used. The protected files will either be stored on the device in its memory 30 or passed to the user equipment for storage by its application. In either case the files are protected. If it is the service transport that is protected then the processor 28 will store the files in a secure area. If the files are for example multimedia then when the user selects one for playing using the user interface on the user equipment the device manages the content protection and either outputs the data locally to its headset or sends it over the secure link to the user equipment client for output.

An aspect of some embodiments of the invention is how the sensitive data is transferred from the device 2 to the user equipment software without breaking any robustness rules. The transfer of information between the device and the user equipment is carried over a secure transfer protocol for example Secure Sockets Layer (SSL). SSL allows applications to communicate without fear of eavesdropping or tampering. This is useful when the digital rights management or conditional access system is on the device rather than the handset. The sensitive data if transferred without this. protocol might be easy to intercept and collect.

SSL is actually two protocols that work together: the SSL Record Protocol and the SSL Handshake Protocol. The SSL Record Protocol, the lower level of the two protocols, encrypts and decrypts variable length records of data for higher level protocols, such as the SSL Handshake Protocol. The SSL Handshake Protocol handles the exchange and verification of application credentials

These protocols on their own may not provide the security required by content companies as the connection needs to be setup by trusted applications on both the device and the user equipment.

Reference is now made to FIG. 3 which shows the software overview of the device 2. The digital broadcast receiver 20 is connected to the driver 40 of a receiver application 42. The receiver application 42 is connected to a secure dock 44 and is clocked thereby. The receiver application is connected to a driver 46 which in turn is connected to a data area or virtual screen in the microprocessor memory 48. The data area or virtual screen 48 is connected via driver 50 to application software for converting the data or virtual display for a secure high speed transfer to the user equipment using peer to peer trusted computing techniques 52. The applications 42 and 52 are connected via the operating system 54.

In general terms, the receiver 20 receives the digital broadcast. This is processed by the receiver application which obtains the relevant data from the received signal and stores it in an appropriate part of the memory. That stored data is then converted so that it can be transferred to the user equipment.

Reference is made to FIG. 4 which shows the set up/registration process for a user to make the connection to the device secure.

In step S1, the Java application or client application is installed on the user equipment by downloading from the device to the user equipment, or a user or service provider and this commences the set up procedure as illustrated in step S1. This application may be sent from the device, via PC sync or the cellular network. The application can be in a format other than Java. The application provides the communication with the device 2 and interfaces to the user equipment resources allowing the device 2 to access them.

A GPRS (general packet radio service) connection, by way of example, is set up in step S2 with the service provider host server. The client application collects unique information from the device, for example its public certificate and from the user equipment for example its phone number or IMEI number and starts a transaction with the service provider host over for example GPRS connection. The service provider host computer confirms the user information/registration and sends a signed data block or certification for example an X.509 certificate to the user equipment application.

In step S3, the unique certificate is stored on the user equipment, the device, the user's SIM card on the device or any other suitable location.

The certificate allows the user equipment client software to set up a trusted secure connection to the device to allow content to be delivered from the device to the user equipment. This is represented by the secure socket authentication using the signed data block for example the X.509 certificate between the device application and the client on the user equipment as represented by steps S4 and S5.

The user equipment client application then renders this information to its screen or audio output in step S6. In other words, the user is able to listen and/or view the content.

In embodiments of the present invention, the device may use an operating system such as windows CE to allow the use of digital rights management such as Microsoft DRM10.

In one embodiment of the present invention, the memory of the device stores the digit rights management (DRM) licences, stream decoder header files such as NSC (NetShowContainer) files and software updates. NSC is used in the Microsoft DRM system for encapsulating information about the media stream and its rights management

In one embodiment of the present invention, the serial number of the microprocessor of the device is used to lock DRM licences, NSC files and software updates.

In embodiments of the present invention, the microprocessor unique serial number can be used to lock protected content to it and not the user equipment providing the user interface.

The SIM card in the handset may be used for conditional access key storage and control. The conditional accesses may run on the device and thus the secure socket communication will provide the two-way communication with the SIM card. In the alternative, the conditional access system may run on the user equipment and thus the secure socket communication will provide the two-way communication with the device to provide the digital data stream to the user equipment client software.

In one embodiment of the present invention, the device may receive content protected with a conditional access system and may allow recording by recoding the file prior to storage with the local security system.

The unique certificate may be stored on the user SIM card. This may allow the user to freely move the SIM and device between-user equipment without compromising the data being transferred.

Embodiments of the present invention can thus lock the protected content to the device and not the phone so that the user can play the content with a number of different phones or other devices. The connection between the device and the user equipment is a point to point connection which may be a wired or wireless connection.

The user equipment may be used by the device to access a remote server for gathering information to decode the screen, for example a unique decoder plug-in, software upgrade or a DRM license. This access may be a one off connection or a permanent connection.

Embodiments of the invention may be such that data can be decoded and encoded to allow two different pieces of equipment with different systems to play the content or the like.

In simple terms some embodiments of the invention may provide a design where mobile TV is received by an accessory device and sent to user equipment for playback. SSL and an additional X.509 certificate, for example, are used to establish that the accessory device trusts the user equipment. DRM decryption of the stream in this case will take place within the accessory device.

In one modification, the arrangement may be such that the device will not transfer DRM-protected video above a pre-determined quality level, such as 320×240 pixels, 30 frames per second. The level is given by way of example only and any other suitable level may be defined as the threshold.

In a further modification the audio play out takes place from the device, via the headphones. This can be applied to DRM mobile TV provided that at least one or both of the device and the user equipment provide an appropriate delay so that the sound is delayed with respect to the picture. In practice, this may mean delaying the sound so that it will synchronize with the pictures.

In yet another modification, the media player on the user equipment is trusted from the perspective of DRM. In this case the DRM-protected streams are passed directly to the user equipment media player and the UE media player is responsible for DRM license storage, DRM decryption as well as video/audio playback and decompression. These functions may then no longer be performed in the device.

It should be appreciated that embodiments are particularly applicable to portable battery operated devices in that embodiments of the invention can be employed in an environment where there are limited constraints on one or more of power, processing and memory costs. However, embodiments of the invention may be used in non portable and/or non battery operated devices where there is not one or more of the listed restraints.

Embodiments of the invention have described a device which is powered by a battery source. It should be appreciated that in alternative embodiments of the invention, the device may be self powered from the user's movement or a radiated power source e.g. inductive may be used.

Additionally or alternatively, embodiments of the invention can be used with limited antenna capabilities such as those provided with a portable device with an antenna. This contrast with for example set top boxes which has external aerials and thus no compromises are required on antenna size, receiver design or performance. However, embodiments of the invention can also be used with set top boxes or other such equipment.

It should be appreciated that embodiments of the invention maybe at least partially implemented in software and accordingly embodiments of the invention also relate to the provision of a computer program comprising computer executable components from implementing at least partially embodiments of the present invention. Such a computer program may be provided on a suitable computer carrying medium.

1. A device comprising:
a receiver for receiving a broadcast;
a processor for processing said broadcast to extract at least one data channel or service from said broadcast;
means for connecting said device to user equipment, said connecting means being arranged to establish a connection with said user equipment whereby said extracted data channel or service can be transferred securely to said user equipment.

2. A device as claimed in claim 1, comprising a memory for storage of extracted data prior to transfer to the user equipment.

3. A device as claimed in any preceding claim, wherein said processor is configured to at least one of, extract, decode, render and/or translate at least part of said extracted data channel or service.

4. A device as claimed in claims 2 and 3, wherein said device is configured to store said decoded and/or rendered data channel or service in memory.

5. A device as claimed in any preceding claim wherein said device is configured, to provide at least one of digital rights management and conditional access for at least part of said extracted data channel or service.

6. A device as claimed in claim 5, wherein said conditional access is run on said device and data is transferred using digital rights management to the said user equipment.

7. A device as claimed in any preceding claim, wherein said device is configured by one of the user device or through the user device connection to a remote system.

8. A device as claimed in any preceding claim, wherein said processor is configured to encode at least part of said extracted data.

9. A device as claimed in claim 8, wherein said device is arranged such that said encoded extracted data is at least one of transferred to said user equipment via said connection means and stored in said memory.

10. A device as claimed in any preceding claim, wherein said means for connecting is arranged so that the established secure connection uses the SSL or similar protocol.

11. A device as claimed in any preceding claim, wherein said device is configured to provide unique information for said device to said user equipment via said connecting means.

12. A device as claimed in claim 11, wherein said unique information comprises a public certificate of said device.

13. A device as claimed in claim 11 or 12, wherein said device is configured to receive a request for said unique information from said user equipment.

14. A device as claimed in any preceding claim, wherein said device comprises a memory for storing a unique certificate for permitting said secure connection to be established.

15. A device as claimed in claim 2 or any claim appended thereto, said memory being configured to store at least one of licences, NSC files and software updates.

16. A device as claimed in claim 2 or any claim appended thereto, wherein at least some of said information stored in said memory is secured in dependence on a serial number of said processor.

17. A device as claimed in any preceding claim, comprising a clock for providing information about a period of use of said extracted data.

18. A device as claimed in claim 16, wherein said microprocessor is configured to compare at least one of time and date in said extracted data to corresponding information provided by said clock.

19. A device as claimed in any preceding claim, wherein said broadcast comprises a digital broadcast.

20. A device as claimed in any preceding claim, wherein said processor is arranged to receive broadcast information and to use said broadcast information enable decoding of at least some of the said extracted data.

21. A device as claimed in any preceding claim, wherein said broadcast comprises digital television, digital radio or download service.

22. A device as claimed in any preceding claim wherein said connection means comprises one or more of a serial connection; a USB connection; a wireless connection; and a Bluetooth connection.

23. A device as claimed in any preceding claim in combination with user equipment, wherein said user equipment comprises a display for displaying at least some of said extracted data.

24. A device as claimed in any of claims 1 to 22 in combination with user equipment, wherein said user equipment comprises a memory for storing for storing a least some of said extracted data.

25. A combination as claimed in claim 23 or 24, wherein said user equipment comprises a mobile telephone, portable media player or personal data assistant PDA.

26. A combination as claimed in any of claims 23 to 25, wherein said user equipment comprises a SIM card arranged to provide at least one of conditional access key storage and control.

27. A combination as claimed in any or claims 23 to 26, wherein the device is arranged in use, to use said user equipment to access a remote server to obtain information to decode a display of said user equipment.

28. A combination as claimed in claim 27, wherein said information comprises one of:
a decoder plug-in; a software upgrade; and a DRM license.

29. A device comprising:
a receiver for receiving a broadcast;
a processor for processing said broadcast to extract an audio signal; and
at least one ear phone for receiving said audio signal.

30. A device as claimed in claim 29, comprising means for connecting said device to user equipment, said processor being arranged to process said broadcast signal to extract a video/audio or data signal, said video/audio or data signal being output to said user equipment via said connecting means.

31. A device as claimed in any preceding claim wherein only extracted data with a quality level below a given threshold is transferred to said user equipment.

32. A device as claimed in any preceding claim, wherein said extracted data comprises an audio signal and a video signal, said device comprising means for providing an audible signal to a user from said audio signal, said video signal being transferred to said user equipment for display on a display of said user equipment, said device further comprising means for ensuring that said audio signal and said video signal are synchronised.

33. User equipment comprising:
means for connecting to a device arranged to receive a broadcast and extract data therefrom, said connecting means being arranged to establish a secure connection with said user equipment whereby said extracted data can be transferred securely to said user equipment,
means for storing at least one access licence; and
means for decrypting said extracted data.

34. A method comprising:
obtaining security information;
using said security information to establish a secure connection between user equipment and a device arranged to receive a broadcast;
transferring information from said broadcast from said device to said user equipment via said secure connection.

35. A method as claimed in claim 34, wherein obtaining security information comprises:
obtaining first information from the device and second information from the user equipment;
sending at least one of said first and second information to a server, and
obtaining from said server said security information.

36. A method as claimed in claim 35 or 36, comprising storing said security information on said user equipment, a SIM card or said device.
